(19) United States
(12) Patent Application Publication
(10) Pub. No.: US 2010/0072292 A1
(43) Pub. Date: Mar. 25, 2010

(54) Indoor Space Heating Apparatus

(76) Inventor: Mark S. Munro, Traverse City, MI (US)

Correspondence Address: REISING ETHINGTON P.C., P O BOX 4390, TROY, MI, 48099-4390, US

(21) Appl. No.: 12/237,782

(22) Filed: Sep. 25, 2008

(51) Int. Cl. F24D 5/02; F24H 3/02; F28F 1/36; G05D 7/00

(52) U.S. Cl. 237/53; 165/121; 165/184; 700/282

(57) ABSTRACT

An indoor space heating apparatus comprising a heat pump including indoor and outdoor heat exchangers in fluid communication with a heat pump compressor. A blower is positioned to blow air over heat rejection coils of the indoor heat exchanger and into an indoor warm air reservoir. A combustion engine drives the heat pump compressor and a furnace transfers combustion heat from the combustion engine to the indoor warm air reservoir.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention relates generally to an indoor space heating apparatus for heating a warm air reservoir such as may be disposed in an indoor space.

2. Description of the Related Art Including Information Disclosed under 37 CFR 1.97 and 1.98

Most known heating furnaces are open combustion systems that primarily use fossil fuels. These systems generally run with efficiencies of approximately 90% (i.e. 90% of the heat generated by combustion is captured and transferred to a heated space). There also exist heating systems that, from an energy balance perspective, are potentially more efficient. Some of these heating systems use commercially produced electricity to run an electric motor driven heat pump that transfers ambient heat extracted from exterior air into a heated space. A typical heat pump of this type has a transfer efficiency or coefficient of performance (COP) of approximately 300% (i.e., for every unit of energy input into the system 3 units of heat are transferred). However, the COP of most electrical power plants that use fossil fuels as an energy source is generally in the area of 30% (i.e. for every unit of energy generated by burning fossil fuels in electrical plants, only 30% is transferred into work energy used to drive generators, while the remaining 70% is lost as discarded heat). Accordingly, there is very little net gain in energy balance. Furthermore the cost of electricity production, transfer, and grid maintenance results in a much higher per unit energy cost than direct-purchase fossil fuel. Therefore, for most applications, current heat pump systems don't offer a favorable cost of operation when compared to that of open combustion furnaces.

Heat pumps can be made marginally cost effective by decreasing the ΔT (temperature gradient) between a heated space and an external heat reservoir. This is most often accomplished by using ground water or sub-frost ground heat as the heat reservoir rather than ambient air. Systems of this type are referred to as geothermal heat pumps. By decreasing the ΔT, the heat pump COP is increased, typically reaching 400% transfer efficiency. Although the 25% advance in overall COP of geothermal over standard heat pump systems typically results in a slight positive cost of operation profile, the substantially higher initial and maintenance costs have limited widespread marketing success.

One approach to improving the COP of a furnace system including a heat pump is disclosed in Greek Patent Application Publication No. 2003100522, which was published Aug. 31, 2005. An internal combustion engine 1 is disposed outside an indoor space 2 to be heated (warm air reservoir) and is drivingly connected to a compressor 3 of a heat pump. A heat capture circuit 4 transfers heat from the internal combustion engine 1 to heat absorption (vapor compression) coils 5 of an outdoor heat pump heat exchanger to increase the efficiency of the heat pump.

It would be desirable to further improve the COP of a furnace system comprising a heat pump.

### BRIEF SUMMARY OF THE DISCLOSURE

An indoor space heating apparatus is provided for heating a warm air reservoir. The apparatus may comprises a heat pump that may include a heat pump compressor, an indoor heat pump heat exchanger in fluid communication with the heat pump compressor and disposed in a warm air reservoir to be heated, and an outdoor heat pump heat exchanger in fluid communication with the compressor and disposed in a cold air reservoir. A blower may be positioned to move air over heat rejection coils of the indoor heat pump heat exchanger and into the warm air reservoir. The apparatus may also include a combustion engine configured to drive the heat pump compressor and a furnace configured to transfer combustion heat from the combustion engine to the warm air reservoir.

### BRIEF DESCRIPTION OF THE SEVERAL VIEWS OF THE DRAWINGS

These and other features and advantages will become apparent to those skilled in the art in connection with the following detailed description and drawings of one or more embodiments of the invention, in which:

FIG. 1 is a schematic block diagram of a prior art indoor space heating system;

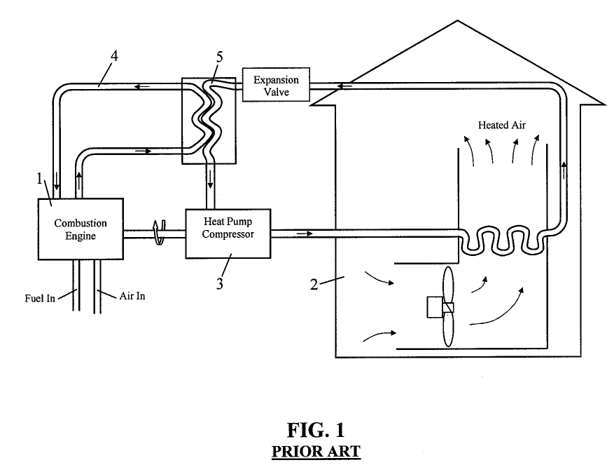

FIG. 2 is a schematic block diagram of an indoor space heating system constructed according to a first embodiment of the invention;

FIG. 3 is a schematic block diagram of an indoor space heating system constructed according to a second embodiment of the invention;

FIG. 4 is a schematic block diagram of an indoor space heating system constructed according to a third embodiment of the invention; and

FIG. 5 is a schematic block diagram of an indoor space heating system constructed according to a fourth embodiment of the invention.

### DETAILED DESCRIPTION OF INVENTION EMBODIMENT(S)

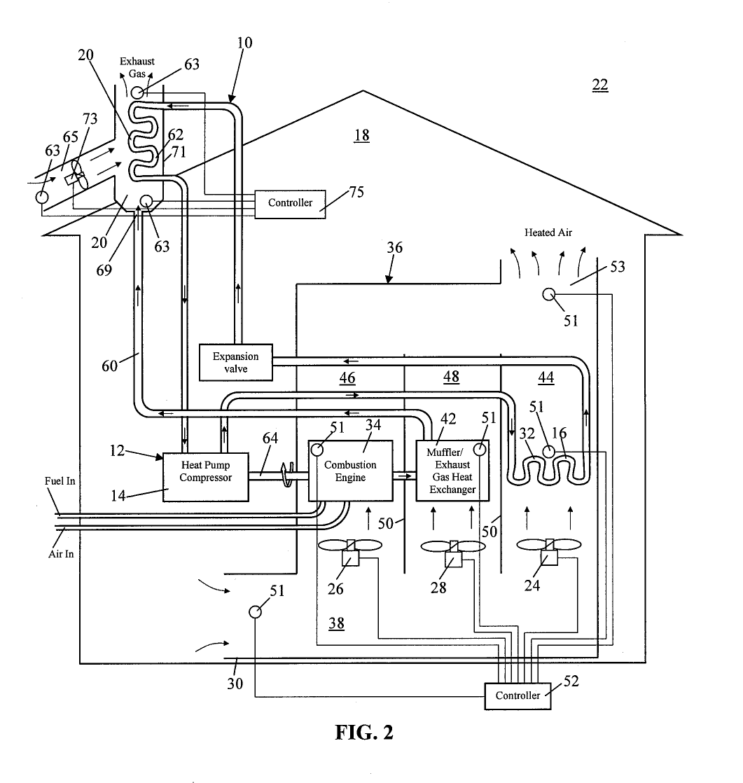

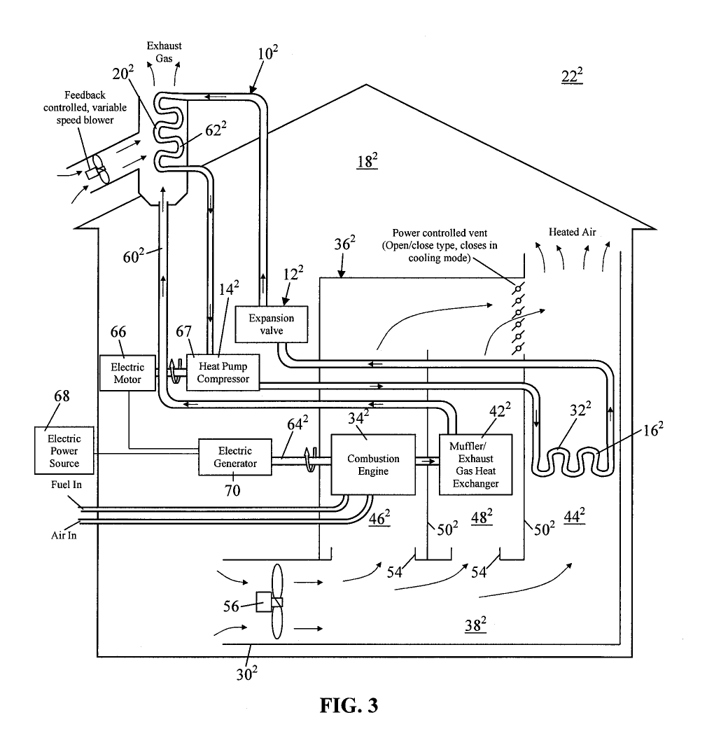

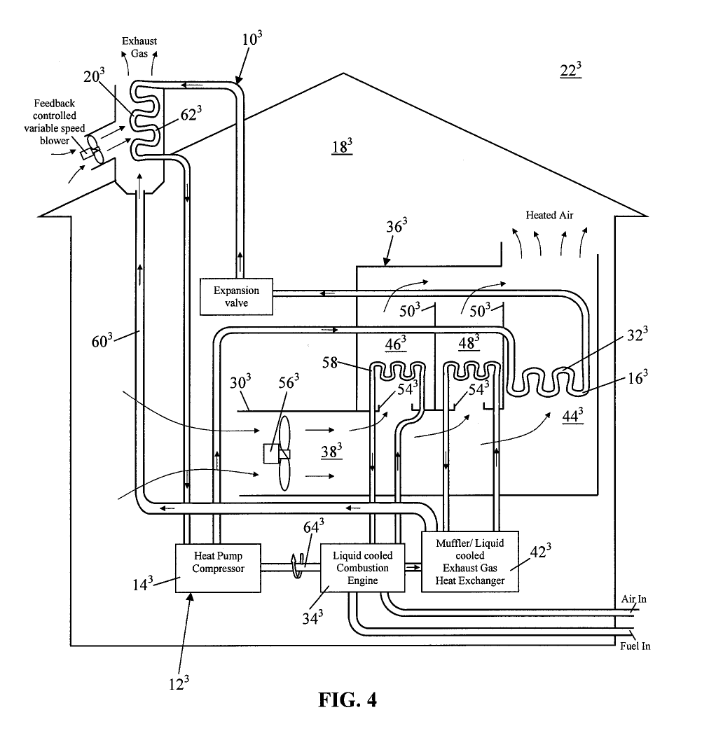

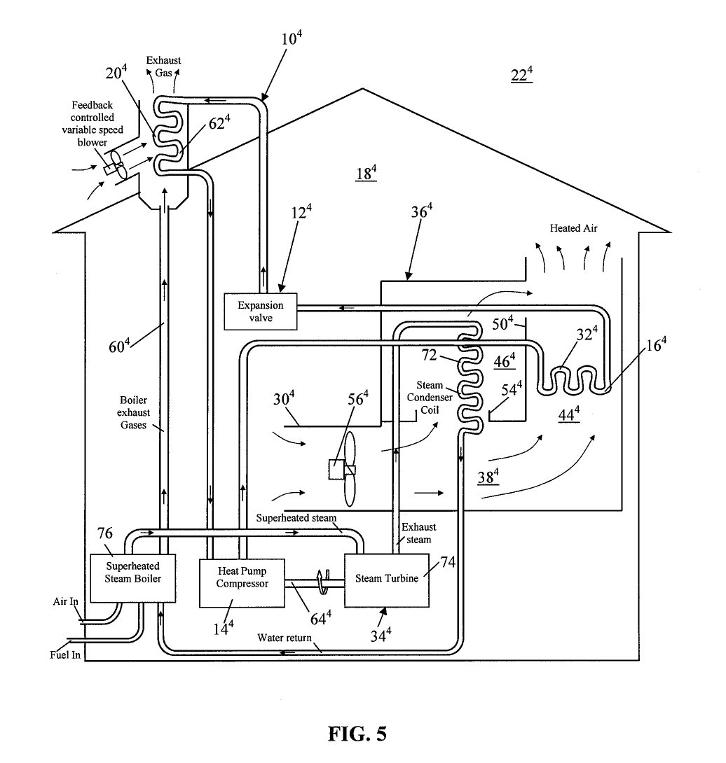

An indoor space heating apparatus for heating a warm air reservoir 18 such as may be disposed in an indoor space is generally indicated at 10 in FIG. 2. A second embodiment is generally indicated at 10² in FIG. 3, a third embodiment is generally indicated at 10³ in FIG. 4, and a fourth embodiment is generally indicated at 10⁴ in FIG. 5. Reference numerals with the superscript numeral two (²) in FIG. 3 indicate alternative configurations of elements that also appear in the first embodiment. Reference numerals with the superscript numeral three (³) in FIG. 4 indicate alternative configurations of elements that also appear in the first and second embodiments. Reference numerals with the superscript numeral four (⁴) in FIG. 5 indicate alternative configurations of elements that also appear in the first, second, and third embodiments. Unless indicated otherwise, where a portion of the following description uses a reference numeral to refer to FIG. 2, that portion of the description applies equally to elements designated by numerals with the superscript two in FIG. 3, the superscript three in FIG. 4, and the superscript four in FIG. 5.

The apparatus 10 may include a heat pump 12 which may include a heat pump compressor 14, an indoor heat pump heat exchanger 16 in fluid communication with the heat pump compressor 14 and disposed in a warm air reservoir 18 such as an indoor space to be heated and an outdoor heat pump heat exchanger 20 in fluid communication with the compressor 14 and disposed in a cold air reservoir 22 such as ambient air outside the indoor space.

One or more blowers 24, 26, 28 may be disposed in the warm air reservoir 18 and positioned to draw air from the warm air reservoir 18 through an air return duct 30 and to blow the air over heat rejection or dissipation coils 32 of the indoor heat pump heat exchanger 16 and back into the warm air reservoir 18. A combustion engine 34 may drive the heat pump compressor 14. The apparatus 10 may also include a furnace 36 that transfers combustion heat directly from the combustion engine 34 to the warm air reservoir 18.

The furnace 36 may be disposed in the warm air reservoir 18 in the indoor space and may include a furnace heating path 38 that draws air from the warm air reservoir 18 and, after the air has been heated, directs the air back into the warm air reservoir 18. A heat dissipation coil 32 of the indoor heat pump heat exchanger 16 and/or at least a portion of the combustion engine 34 may be disposed in the furnace heating path 38. An engine exhaust heat exchanger 42, which may also comprise an exhaust muffler, is configured to capture and transfer heat from combustion engine exhaust to the warm air reservoir 18, may be disposed in the furnace heating path 38 as well.

As shown in FIG. 2, the furnace heating path 38 may include three parallel heating path segments 44, 46, 48 which may be divided from one another by intervening walls 50. The heat dissipation coil 32 of the indoor heat pump heat exchanger 16 may be disposed in a first segment 44 of the three heating path segments, at least a portion of the combustion engine 34 may be disposed in a second segment 46 of the three heating path segments and arranged to direct airflow parallel to airflow through the first furnace heating path segment 44, and the exhaust heat exchanger 42 may be disposed in a third segment 48 of the three heating path segments and arranged to direct airflow parallel to the airflow through the first and second segments 44, 46. This segmentation of the furnace heating path 38 maximizes heat extraction through fractionated air flow.

As is also shown in FIG. 2, the apparatus 10 may include a furnace flow regulator that regulates air flow rate over the heat dissipation coils 32 of the indoor heat pump heat exchanger 16, the engine 34, and the exhaust heat exchanger 42 in response to temperature signals received from furnace temperature sensors 51 that may be located on or adjacent the engine 34, the exhaust gas heat exchanger 42, the heat pump heat dissipation coil 32, the furnace air return duct 30, and a furnace air outlet manifold 53. As shown in FIG. 2, the furnace flow regulator may comprise the first, second, and third blowers 24, 26, 28, which may be feedback-controlled variable-flow blowers, and may be positioned to move air through the respective first, second, and third furnace heating path segments 44, 46, 48. The flow regulator may include a furnace blower controller 52 electrically coupled to the variable flow blowers 24, 26, 28 and the furnace sensors 51 and programmed to provide active control of airflow through the three furnace heating path segments 44, 46, 48 by modulating operation of the variable flow blowers 24, 26 28 in response to signals received from the furnace sensors 51. More specifically, the furnace blower controller 52 may be programmed to initially command each blower 24, 26, 28 to operate at an empirically-derived minimum flow rate when its corresponding segment 44, 46, 48 reaches a predetermined minimum temperature level during a duty cycle, then to command each operating blower to incrementally increase the flow rate through its corresponding segment as its segment sensor temperature increases, either until the each operating blower reaches a maximum blower velocity or until a steady state temperature is reached. At the end of a duty cycle, the furnace blower controller 52 may command each operating blower to incrementally decrease flow through its respective segment in response to decreasing segment sensor temperatures until an empirically derived minimum temperature, or furnace inlet air temperature, is reached. The furnace blower controller 52 may also be programmed to command a furnace duty cycle shut off if any segment or mix air furnace outlet temperature exceeds an empirically determined maximum. The furnace blower controller 52 may also be programmed to restart when an active cycle minimum temperature level is reached. During an active cycle, over temperature cool down, the furnace blowers 24, 26, 28 continue to function per on phase algorithms.

As is also shown in FIG. 2, the apparatus 10 may include an outdoor heat exchanger flow regulator that regulates air flow rate over the heat absorption coils 62 of the outdoor heat pump heat exchanger 20 in response to temperature signals received from temperature outdoor heat pump heat exchanger sensors 63 that may be located on or adjacent an ambient air intake manifold 65 of the outdoor heat exchanger 20, an exhaust gas inlet 69 of the outdoor heat pump heat exchanger 20, and in the air path defined by an air flow containment structure 71 of the outdoor heat pump heat exchanger 20. As shown in FIG. 2, the outdoor heat exchanger flow regulator may comprise a feedback-controlled variable-flow blower 73 that may be positioned to move air along an ambient air path defined by the ambient air intake manifold 63. The outdoor flow regulator may also include an outdoor heat exchanger blower controller 75 electrically coupled to the variable-flow blower 73 and the outdoor heat exchanger sensors 63 and programmed to provide active control of airflow through the ambient air intake manifold 63 by modulating operation of the variable flow blower 73 in response to signals received from the outdoor heat exchanger sensors 63. More specifically, the outdoor heat exchanger blower controller 75 may be programmed to modify the flow rate of the blower 73 per an empirically derived algorithm, with flow rate being a direct function of ambient air temperature and combustion engine exhaust gas temperature at the inlet 69 of the heat absorption coil air flow containment structure 71. The heat absorption coil outlet temperature is monitored to ensure expected outlet air temperature range is maintained per algorithm parameters. If the outlet temperature falls below the expected range, the controller commands the blower 73 to incrementally increase the blow flow rate until either a target temperature or a maximum blower flow rate is reached.

Alternatively or additionally, and as shown in FIG. 3, the flow regulators may include flow regulating vents 54 positioned to provide passive control of airflow from a single blower 56 that may be disposed in the warm air reservoir 18 upstream from the furnace heating path segments 44², 46², 48² in a position to draw air from the warm air reservoir 18 through an air return duct 30² and to blow the air along the furnace heating path 38 and through the furnace heating path segments 44², 46², 48².

As shown in FIG. 2, the combustion engine 34 may be disposed in the furnace heating path 38 as a first stage heat exchanger for the furnace 36. This allows the furnace 36 to capture heat from the engine 34 by passive heat exchange. In other words, the furnace 36 may direct heated air through the furnace heating path 38 into the warm air reservoir 18 while capturing heat by convective heat transfer from the engine 34 to air directed over the engine 34. Placing the engine 34 in the furnace heating path 38 allows for the capture of both combustion energy that is not converted to work (typically 70 to 80% of the total energy of combustion) and frictional heat.

As shown in FIG. 4, where the combustion engine 34³ includes a liquid cooling circuit 56 that may comprise a radiator 58, the radiator 58 may be disposed in the furnace heating path 38³ or a segment of a multi-segment heating path as a second stage heat exchanger. The rest of the engine 34³ may be disposed outside the furnace heating path 38³ within the heated space.

As shown in FIG. 2, the apparatus 10 may include an engine exhaust channel 60 that extends from the combustion engine 34 to heat absorption coils 62 of the outdoor heat pump heat exchanger 20 and that directs exhaust gases from the combustion engine 34 over the heat absorption coils 62. This essentially provides active heat exchange and capture of residual engine heat and enhances heat pump efficiency by decreasing the temperature gradient between the heat absorption coils 62 and heat dissipation coils 32 of the heat pump 12.

The exhaust heat exchanger 42 may be disposed in the furnace heating path 38 to allow the furnace 36 to capture and transfer heat from the combustion engine exhaust into the warm air reservoir 18 in the indoor space. The third variable flow blower 28 may be positioned to draw air from the warm air reservoir 18 through an air return duct 30, to move that air over the exhaust heat exchanger 42 and back into the warm air reservoir 18. Using known passive heat exchanger technology, this arrangement should allow for approximately 90% heat capture from engine exhaust gases for primary furnace 36 heat generation.

The combustion engine 34 may be drivingly connected to the heat pump compressor 14 by a mechanical linkage 64 and may mechanically drive the heat pump compressor 14 through the mechanical linkage 64. Alternatively, and as shown in the second embodiment of FIG. 3, the apparatus 10² may include an electric motor 66 drivingly connected to the heat pump compressor 14² by a mechanical linkage 67 to drive the heat pump compressor 14² when supplied with electrical power from an external electrical power source 68 such as a commercial electrical power grid. The apparatus 10² may further include an electrical power generator 70 electrically coupled with the electric motor 66 to power the electric motor 66. The combustion engine 34² may be drivingly connected to the electrical power generator 70 via a mechanical linkage 64² to drive the electrical power generator 70 through the mechanical linkage 64².

As is also shown in the embodiment of FIG. 3, the apparatus 10² may be configured to be operable in a cooling mode in which the indoor air reservoir defined by the indoor space, in which the indoor heat pump heat exchanger 16² may be disposed, may be an indoor air reservoir to be cooled. The outdoor air reservoir, e.g., the ambient air outside the indoor space, in which the outdoor heat pump heat exchanger 20² may be disposed, may be an outdoor air reservoir into which heat is to be rejected. Accordingly, the heat rejection coils of the indoor heat pump heat exchanger 16² may be converted to operation as heat absorption coils, and the heat absorption coils of the outdoor heat pump heat exchanger 20² being converted to operation as heat rejection coils 32, the first blower being disposed in the indoor air reservoir and positioned to draw air from the indoor air reservoir through an air return duct 30² and to blow the air over the coils 62² of the indoor heat pump heat exchanger 16² and back into the indoor air reservoir. When operating in cooling mode, the electric motor 66 may obtain electrical power to drive the heat pump compressor 14² from an external electrical power source 68 such as a commercial electrical power grid.

As shown in FIG. 5, the combustion engine 34⁴ of the apparatus 10⁴ may be an external combustion steam engine. According to this embodiment, a steam condenser coil 72 of the engine 34⁴ may be disposed in one segment 46⁴ of the furnace heating path 38⁴ and may be arranged to receive exhaust steam from a steam turbine 74 of the engine 34⁴. Water condensed from the steam may be returned to a boiler 76 of the engine 34⁴. The boiler 76 may comprise a high efficiency, rapid heating pipe boiler system producing superheated steam to power the turbine 74. Both the steam turbine 74 and boiler 76 may be disposed in the heated space and the turbine 74 may directly power the heat pump compressor 14⁴ via a drive shaft or other suitable mechanical linkage 64⁴. The turbine 74 could, alternatively, drive an electrical power generator that provides electricity to drive an electric motor powering the heat pump compressor as shown in the embodiment of FIG. 3. In addition, exhaust gas exiting a steam boiler 76 of the engine 34⁴ may be passed over the heat absorption coils 62⁴ of the outdoor heat pump heat exchanger 20⁴.

The apparatus is able to capture and transfer heat directly from a combustion engine to an indoor space, to further increase the efficiency of a heat pump, and to reduce the importance or impact of heat engine efficiency and exhaust gas heat exchanger efficiency and, therefore, the size and cost of the heat pump as well as the combustion engine used to drive the compressor of that heat pump. By transferring combustion engine exhaust heat to heat absorption coils of the outdoor heat pump heat exchanger of a heat pump the apparatus is able to capture essentially all residual energy of combustion. This can result in nearly 100% use of heating fuel and can provide an overall furnace 36 efficiency of up to 180%—twice that obtainable in a conventional open combustion furnace 36 or heat pump 12 system.

This description, rather than describing limitations of an invention, only illustrates embodiments of the invention recited in the claims. The language of this description is therefore exclusively descriptive and is non-limiting.

Obviously, it's possible to modify this invention from what the description teaches. Within the scope of the claims, one may practice the invention other than as described above.

What is claimed is:

1. An indoor space heating apparatus for heating a warm air reservoir, the apparatus comprising:
a heat pump including a heat pump compressor, an indoor heat pump heat exchanger in fluid communication with the heat pump compressor and disposed in a warm air reservoir to be heated, and an outdoor heat pump heat exchanger in fluid communication with the compressor and disposed in a cold air reservoir;
a blower positioned to move air over heat rejection coils of the indoor heat pump heat exchanger and into the warm air reservoir;
a combustion engine configured to drive the heat pump compressor; and
a furnace configured to transfer combustion heat from the combustion engine to the warm air reservoir.

2. An indoor space heating apparatus as defined in claim 1 in which:
the furnace includes a furnace heating path configured to direct heat into the warm air reservoir, and
one or more components selected from the group of components consisting of a heat dissipation coil of the indoor heat pump heat exchanger, at least a portion of the combustion engine, and an exhaust heat exchanger configured to capture and transfer heat from combustion engine exhaust to the warm air reservoir, are disposed in the furnace heating path.

3. An indoor space heating apparatus as defined in claim 2 in which at least one of the components selected from the group of components is disposed in a first segment of the furnace heating path and at least one additional component selected from the group of components is disposed in a second segment of the furnace heating path.

4. An indoor space heating apparatus as defined in claim 3 in which the apparatus includes a flow regulator configured to regulate air flow rate over the one or more components selected from the group of components and comprising one or more flow regulation components disposed in one or both furnace heating path segments and selected from the group of flow regulation components consisting of a feedback-controlled variable-flow blower and a flow regulating vent.

5. An indoor space heating apparatus as defined in claim 2 in which the combustion engine includes a liquid cooling circuit comprising a radiator and the radiator is disposed in the furnace heating path.

6. An indoor space heating apparatus as defined in claim 1 in which the furnace is configured:
to direct heated air through the furnace heating path into the warm air reservoir; and
to capture heat by convective heat transfer from the engine to air directed over the engine.

7. An indoor space heating apparatus as defined in claim 1 in which a blower is positioned to blow air along the furnace heating path, over the engine, and into the warm air reservoir.

8. An indoor space heating apparatus as defined in claim 1 in which the combustion engine is disposed in the warm air reservoir.

9. An indoor space heating apparatus as defined in claim 1 in which the apparatus includes a combustion engine exhaust heat exchanger configured to capture heat from combustion engine exhaust.

10. An indoor space heating apparatus as defined in claim 9 an engine exhaust channel that extends from the combustion engine to the heat absorption coils of the outdoor heat pump heat exchanger and is configured to direct exhaust gases from the combustion engine over the heat absorption coils.

11. An indoor space heating apparatus as defined in claim 9 in which the exhaust heat exchanger is configured to capture and transfer heat from combustion engine exhaust to the warm air reservoir.

12. An indoor space heating apparatus as defined in claim 11 in which a blower is positioned to move air over the exhaust heat exchanger and into the warm air reservoir.

13. An indoor space heating apparatus as defined in claim 1 in which the combustion engine is drivingly connected to the heat pump compressor and is configured to mechanically drive the heat pump compressor.

14. An indoor space heating apparatus as defined in claim 1 in which the apparatus includes an electric motor drivingly connected to the heat pump compressor and configured to drive the heat pump compressor.

15. An indoor space heating apparatus as defined in claim 14 in which the apparatus includes an electrical power generator electrically coupled with the electric motor and configured to power the electric motor, the combustion engine being drivingly connected to the electrical power generator and configured to drive the electrical power generator.

16. An indoor space heating apparatus as defined in claim 1 in which the apparatus is configured to be operable in a cooling mode in which the indoor heat pump heat exchanger is disposed is an indoor air reservoir to be cooled and the outdoor heat pump heat exchanger is disposed an outdoor air reservoir into which heat is to be rejected, the heat rejection coil of the indoor heat pump heat exchanger being convertible to operation as a heat absorption coil, and the heat absorption coil of the outdoor heat pump heat exchanger being convertible to operation as a heat rejection coil, the first blower being positioned to blow air over heat absorption coils of the indoor heat pump heat exchanger and into the indoor air reservoir.

17. An indoor space heating apparatus as defined in claim 16 in which the apparatus includes an electric motor drivingly connected to the heat pump compressor and configured to drive the heat pump compressor.

18. An indoor space heating apparatus as defined in claim 17 in which the apparatus includes an electrical power generator electrically coupled with the electric motor and configured to power the electric motor, the combustion engine being drivingly connected to the electrical power generator and configured to drive the electrical power generator.

19. An indoor space heating apparatus as defined in claim 2 in which the combustion engine is an external combustion steam engine, and in which a steam condenser coil of the engine is disposed in the furnace heating path.

20. An indoor space heating apparatus as defined in claim 6 in which exhaust gas exiting a steam boiler of the engine may be passed over the heat absorption coil of the outdoor heat pump heat exchanger.
